(19) United States
(12) Patent Application Publication
(10) Pub. No.: US 2021/0211510 A1
(43) Pub. Date: Jul. 8, 2021

(54) PINNING SERVICE FUNCTION CHAINS TO CONTEXT-SPECIFIC SERVICE INSTANCES

(71) Applicant: IDAC Holdings, Inc., Wilmington, DE (US)

(72) Inventors: Dirk Trossen, London (GB); Ulises Olvera-Hernandez, London (GB)

(73) Assignee: IDAC Holdings, Inc., Wilmington, DE (US)

(21) Appl. No.: 17/056,630

(22) PCT Filed: May 17, 2019
(86) PCT No.: PCT/US2019/032989

§ 371 Date: Nov. 18, 2020

Related U.S. Application Data
(60) Provisional application No. 62/673,543, filed on May 18, 2018.

(51) Int. Cl. H04L 29/08; H04L 12/911

(52) U.S. Cl. CPC H04L 67/16; H04L 47/82

(57) ABSTRACT

Pinning service function chains to specific points of execution (e.g., service instances) in a network system may be provided. Available service instances may be solicited from service hosts. The service hosts may be exposed under a context identifier (e.g., a slicing identifier or a device identifier). A subset of the available service instances may be selected to serve a client. The client may be identified by a client-specific identifier. The selected service hosts may be instructed to register the selected service instances under a name that ties the client identifier and the service function identifier into a single name. The client may use the single name to initiate a service function chain. Service function instances may initiate a next hop in the named service function chain through using the client identifier derived from an incoming request.

### CROSS-REFERENCE TO RELATED APPLICATIONS

This application claims the benefit of provisional U.S. patent application No. 62/673,543, filed May 18, 2018, the disclosure of which is incorporated herein by reference in its entirety.

### BACKGROUND

Service chaining may be a concept to link execution of packet-level services together as a sequence or chain of service functions being executed while a packet traverses a network. For example, a service function chaining (SFC) may signify traversal of a Network Address Translator (NAT) before being sent to a load balancer, which may be placed before the packet arrives at a final destination. The SFC may exemplify communication that may often occur in end user traffic where an end user may reside behind a NAT while a final destination (e.g., a web server in a data center) may be placed behind a load balancer. Exposing relations as SFCs may enable an operator to manage traffic flow, such as through software-defined networking (SDN) infrastructure.

### SUMMARY

Systems, methods, and instrumentalities are disclosed herein that may enable pinning service function chains to points of execution, such as service instances, in a network system. Available service instances may be solicited from service hosts. The service hosts may be exposed under a context identifier (e.g., a slicing identifier, a device identifier, and the like). A subset of the available service instances may be selected to serve a client. The client may be identified by a client-specific identifier. The selected service hosts may be instructed to register the selected service instances under a name that ties the client identifier and the service function identifier into a name (e.g. a single name). The client may use the name to initiate a service function chain. Service function instances (e.g., each service function instance) may initiate a next hop in the named service function chain by using the client identifier, which may be derived from an incoming request.

System, methods, and instrumentalities are disclosed herein that may implement a service function manager (SFM) to assign one or more resources to a client through a pinned service function chain (SFC). For example, a device may implement an SFM to assign one or more resources to a client through a pinned SFC. The device may be a wireless transmit/receive unit (WTRU). The device may comprise a memory and a processor. The processor may be configured to perform a number of actions. For example, a service context and a client identifier that may be associated with the client may be identified. One or more assignable resources that may be assigned to the client may be discovered, for example, using the identified service context. One or more resources may be assigned to the client from the discovered one or more assignable resources. A resource naming scheme may be determined using the client identifier. At least a resource address for the assigned one or more resources may be generated using the resource naming scheme. A first message may be sent to a host to register the assigned one or more resources to the client under at least the resource address for the assigned one or more resources. A second message may be sent to the client that may comprise at least the resource address for the assigned one or more resources to initiate the pinned SFC.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example system diagram that may be used for soft-slicing a 5G control plane by pinning specific service instances to specific clients.

FIG. 3 illustrates an example system diagram that may be used to implement a service function manager (SFM).

FIG. 4 illustrates an example message sequence chart that may be used for pinning one or more service functions to one or more service hosts.

FIG. 5 illustrates an example system diagram that may be used to implement an SFM that may assign one or more resources to a client through a pinned service function chain (SFC).

FIG. 6 illustrates an example system diagram that may be used to implement an SFM that may assign one or more resources to a client through a pinned SFC.

FIG. 7 illustrates an example system diagram that may be used to assignment a visiting customer quota within a service slice, such as a super slice.

### DETAILED DESCRIPTION

A detailed description of illustrative embodiments will now be described with reference to the various Figures. Although this description provides a detailed example of possible embodiments, it should be noted that the details are intended to be exemplary and in no way limit the scope of the application.

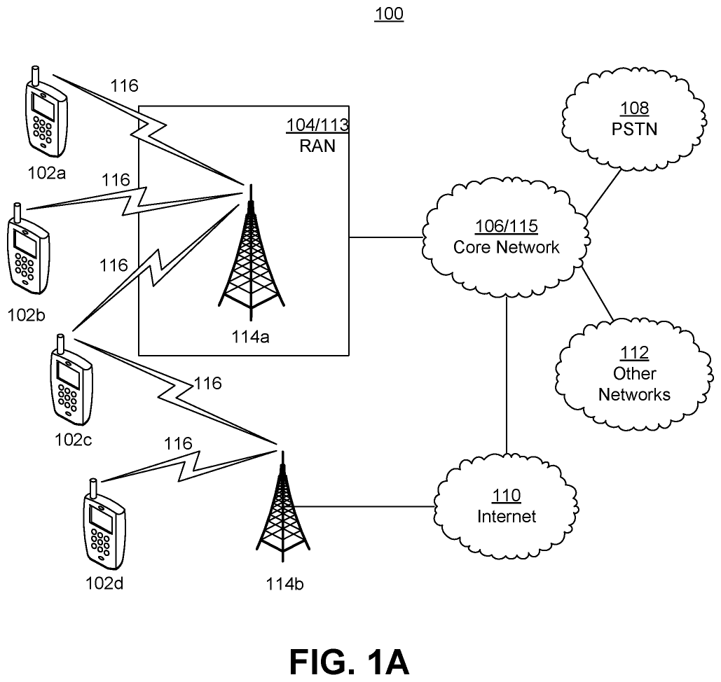

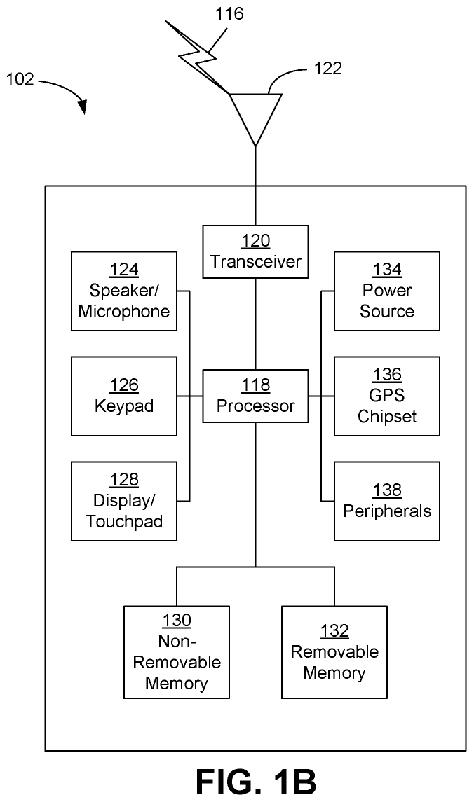

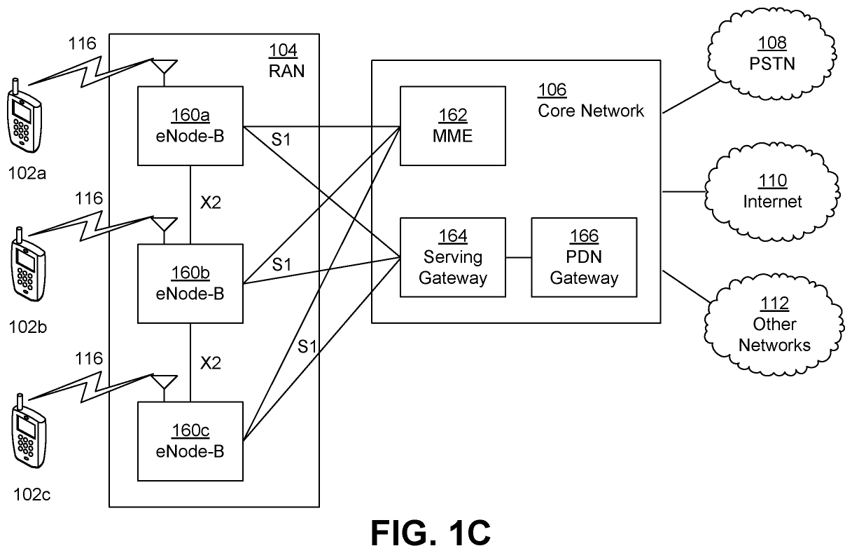

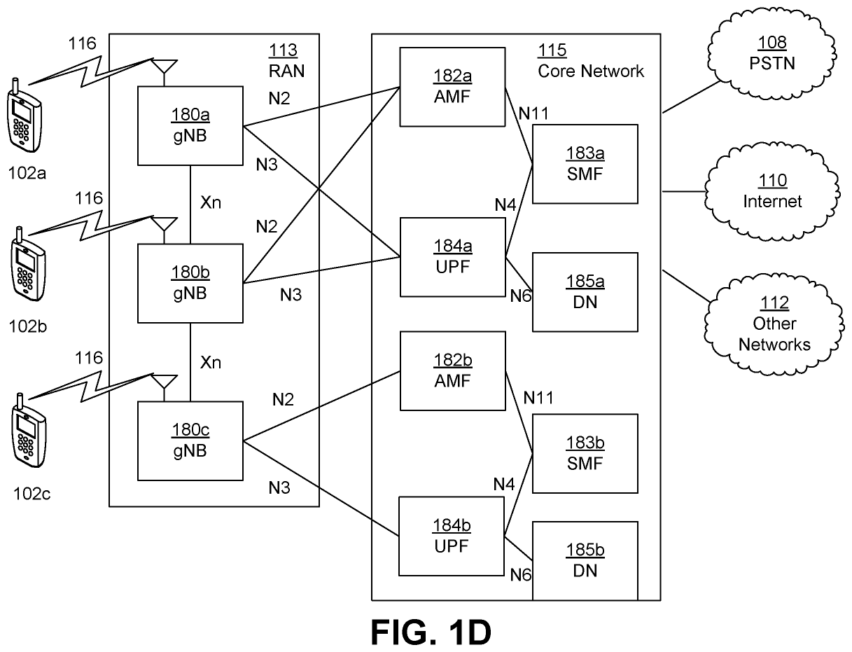

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a. 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a. 102b, 102c may implement radio technologies such as IEEE 802.11 (i.e., Wireless Fidelity (WiFi), IEEE 802.16 (i.e., Worldwide Interoperability for Microwave Access (WMAX)), CDMA2000. CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller. Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from abase station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor an altimeter, alight sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception)) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a. 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled LS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac, 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, may support for network slicing (e.g., handling of different PDU sessions with different requirements), may select a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like. Service functions (e.g., any service function) provided by the network functions specified in CN 115 (e.g., managing and allocation of IP addresses defined within the SMF network function) may run as a distinct service function instance, e.g., independently from the network function itself. Service functions instances may be accessed directly through routing mechanisms as disclosed herein, e.g., by identifying the service function instance through a URI.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are disclosed herein that may enable pinning service function chains to points of execution, such as service instances, in a network system. Available service instances may be solicited from service hosts. The service hosts may be exposed under a context identifier (e.g., a slicing identifier or a device identifier). A subset of the available service instances may be selected to serve a client. The client may be identified by a client-specific identifier. The selected service hosts may be instructed to register the selected service instances under a name that ties the client identifier and the service function identifier into a name (e.g. a single name). The client may use the name to initiate a service function chain. A service function instance (e.g., each service function instance) may initiate a next hop in the named service function chain through using the client identifier derived from an incoming request. The embodiments described herein may be applied to one or more of a layer-3 (L3), an application layer, and the like. The embodiments described herein may be realized in a dedicated (e.g., edge) infrastructure element or may be integrated in a WTRU.

System, methods, and instrumentalities are disclosed herein that may implement a service function manager (SFM) to assign one or more resources to a client through a pinned service function chain (SFC). For example, a device may implement an SFM to assign one or more resources to a client through a pinned SFC. The device may be a wireless transmit/receive unit (WTRU). The device may comprise a memory and a processor. The processor may be configured to perform a number of actions. For example, a service context and a client identifier associated with the client may be identified. One or more assignable resources that may be assigned to the client using the identified service context may be identified. One or more resources may be assigned to the client from the discovered one or more assignable resources. A resource naming scheme may be determined using the client identifier. At least a resource address for the assigned one or more resources may be generated using the resource naming scheme. A first message may be sent to a host to register the assigned one or more resources to the client under at least the resource address for the assigned one or more resources. The host may provide at least a resource from the assigned one or more resources to the client A second message may be sent to the client that may comprise at least the resource address for the assigned one or more resources to initiate the pinned SFC. The service context may be identified using at least one of a configuration or a user input.

The one or more assignable resources that may be assigned to the client using the identified service context may comprises a number of actions. For example, the service naming scheme may be derived from the identified service context And the one or more assignable resources may be addressed using the service naming scheme.

As another example, a list of resources may be determined from the host. A selection criterion for the client may be determined. The one or more assignable resources that may be assigned to the client may be determined from the list of resources using the selection criteria for the client.

As another example, a list of resources may be determined from the host One or more assignable resources that may be assigned to the client may be determined from the list of services using a slice type.

Available service instances may be solicited from service hosts. The service hosts may be exposed under a known context identifier, such as a slicing identifier or a device identifier. A subset of available service instances may be selected to serve a client that may be identified by a client identifier. A selected service host may be instructed to register a selected service instance under a name that may tie a client identifier and a service function into a name (e.g. a single name). A client may use the name to initiate a service function chain. A service function instance (e.g. each service function instance) may initiate a next hop in the named service function chain by using a client identifier that may be derived from an incoming request.

A service function manager may identify a service context, for example, a set of services that may fulfill a use case based on preconfigured or user provided inputs. A service function manager may discover a list of available services from hosts, that may satisfy a service context that may be derived. A service function manager may instruct service instances to register client ID specific FQDNs. A client may initiate an SFN to satisfy a user case (e.g. URLLC—ultra reliable low latency compute—services) by addressing the SFC using its client ID.

Service chaining may be a concept to link execution of packet-level services together as a sequence or chain of service functions being executed while a packet traverses a network. For example, a service function chain (SFC) may signify traversal of a Network Address Translator (NAT) before being sent to a load balancer, which may be placed before the packet arrives at the final destination. The SFC may exemplify communication that may occur in end user traffic where an end user may reside behind a NAT while a final destination (e.g., a web server in a data center) may be placed behind a load balancer. Exposing relations as SFCs may enable an operator to manage traffic flow, such as through software-defined networking (SDN) infrastructure.

Relationships in SFCs may be captured by Service Function Paths (SFPs). SFPs may capture an intended flow of a packet through a network. For example, references to next hop information may be captured in a Network Locator Map at a traversing switch (e.g. each traversing switch). For example, SFPs may capture the intended flow as references to next hop information that may be captured in a Network Locator Map at a (e.g. each) SFC forwarder, which may be a service function forwarder (SFF). A packet may traverse the SFF and may be captured in the Network Locator Map as it is traversing the SFF.

An SFP may include an IP address of a NAT device, such as a home gateway, and may be followed by a load balancer of a data center. SFCs may complement standard IP-based routing through an overlay captured in SFP information. SFC architecture may use a Network Services Header (NSH) to capture SFP information.

SFP information may be described as Layer 2 (e.g., MAC addresses), Layer 3 (e.g., IP addresses of next hops) information, and the like. This may be motivated by certain use cases, e.g., a NAT and load-balancing use case. The scope of SFP information may be extended beyond Layer 3 through capturing named relations, e.g. those described by URLs in a web transaction. For example, an SFP may be able to include URL information, and a traversal after a NAT may be described as a next hop to a given URL. Delivery to named relations may be handled by a dedicated service function, such as service request routing (SRR). An SRR may be responsible for directing traffic to a named relation (e.g., a given URL) to an appropriate service instance. For example, an SRR may use forwarding methods, such as path-based forwarding, to route messages to a service function instance in a chain. In the presence of several service instances, an SRR may select a suitable service instance and direct traffic accordingly. The overall chain may remain the same (e.g., the SFP may include information on a NAT IP address and the given URL named relation), while traffic may flow to different service instances, which may depend on the handling of service routing at the SRR function, e.g., selecting the next service function instance through path policy enforcement SRR functionality may be embedded into an SFF component of a baseline SFC architecture, which may result in an extended and backward compatible name-based SFF (nSFF), which may not expose a service function element for routing.

Application function offloading may be provided. Relations may be extended onto a named service level that may be used in an application function offloading scenario. For example, three named functions may be created: receive.virtdev.com, process.virtdev.com, and display.virtdev.com. The three named functions may be used for receiving a video stream from a video source and providing an (e.g. a single) image as output (e.g. receive.virtdev.com); receiving an (e.g. a single) image, performing predefined processing, and providing a processed image as output (e.g. process.virtdev.com); and receiving an image and displaying it onto a user interface (e.g. display.virtdev.com). A resulting SFC may be described as
Display<->Process<->Receive
   where the display function may initiate the SFC by pulling images from the process function, which may pull an image from the receive function and may receive video from the internet.

The three functions may be designed to run locally, e.g. on a mobile device. The three functions may be installed as an (e.g. a single) application on the device and may serve remote requests (e.g., sent from other devices in a networked system). By disabling local execution of one of the three functions on a first device, execution may be redirected to a second device where a function (e.g. all functions) may be available. An SRR function may be used to direct service requests to a suitable service instance. Suitability may be determined by, e.g., shortest path distance, while other policies may be realized in an SRR function. Application functions (e.g., the display, process, and receive functions) may be offloaded to other devices in a flexible and dynamic manner while overall application-level service flow may remain the same. This may apply to functions below the typical application API of a mobile device. This concept may be called the establishment of a virtual device, which may be composed of device functions located in a number of other devices.

Service-based architecture (SBA) for a 5G control plane may be provided. Name-based relations in SFCs may be used to provide an SBA in 5G control planes (CPs). HTTP may be used as a protocol (e.g. the main protocol) to provide SVA in 5G CPs following SBA. This may lift message exchange between control plane services (CPSs) onto the level of a named exchange. For example, the message exchange to establish an authenticated session (e.g., PDU session as referred to in 3GPP) may be described as
WTRU<->amf.3gpp.org<->smf.3gpp.org.
   The names used in this example are illustrative and other names may be used.

The introduction of named relations may allow for execution in different CPS (control plane service) instances, which may be used to support dynamic and automatic addition, update, and planned removal of CP NFs and/or services in virtualized environments. Stateless execution of a CPS transaction may allow the direction of a message (e.g., to a particular service instance) to change from one transaction to another. A service operation may be designed to avoid long-living WTRU-specific bindings between service instances (e.g. specific service instances), e.g., by separating functional processing from state repository or other mechanisms. SRR functions (or a name based SFF equivalent) may provide a suitable basis for flexible SFC realization. The nature of SFC transactions may be a set of procedures, e.g., message flows that may be used for non-SBA based control planes.

Managing resource quota for visiting (e.g. roaming) customers for a service type (e.g. eMBB), may use name-based SBA interactions. For example, managing resource quotas for a roaming customer may be realized as a slice in the home operator.

As described herein, SFC transactions may provide the ability to flexibly direct traffic to any suitable service instance. The choice of what may be suitable may be left (e.g., entirely left) to the realization of an SRR function. For example, a shortest path distance may be an often-applied policy, which may result in traffic for a next hop of an SFP being sent to a topologically near service instance. The embodiments described herein may be extended to include situations where a choice of service instances may be pinned to service instances for operation reasons.

It may be desirable to choose mobile devices that may be suited to the service function being executed e.g. in the function offloading use case. For example, there may be three devices available in a networked system, including one initiating device. A non-initiating device (e.g. one non-initiating device) may provide a smaller display while the other may provide a larger display. A display function may be redirected to the device with the smaller display, e.g., if the device with the smaller display may be topologically closer to the initiating device even though there may be a more suitable device nearby. Controlling selection through an SRR may be possible, but it may be unlikely that the service routing function may have the information to perform selection among the choices of service instances.

It may be desirable to isolate (e.g., soft-slice) service instances for certain WTRUs, e.g., in the SBA use case. For example, a provider of the service instances (e.g., a mobile network operator) may prefer to have one or more customer WTRUs handled by a set of service instances, e.g. without pre-configuring this set of services within a predefined network slice. The provider may choose to provide a separate end-to-end network slice for a desired set of WTRUs. The separate network slice may be managed. Pinning the execution of service functions to an instance may provide a way to direct certain control plane traffic to certain instances, e.g., without slicing overhead. This be useful, for example, if considering scenarios where such pinning may dynamically change, e.g., due to WTRU mobility or load conditions changing.

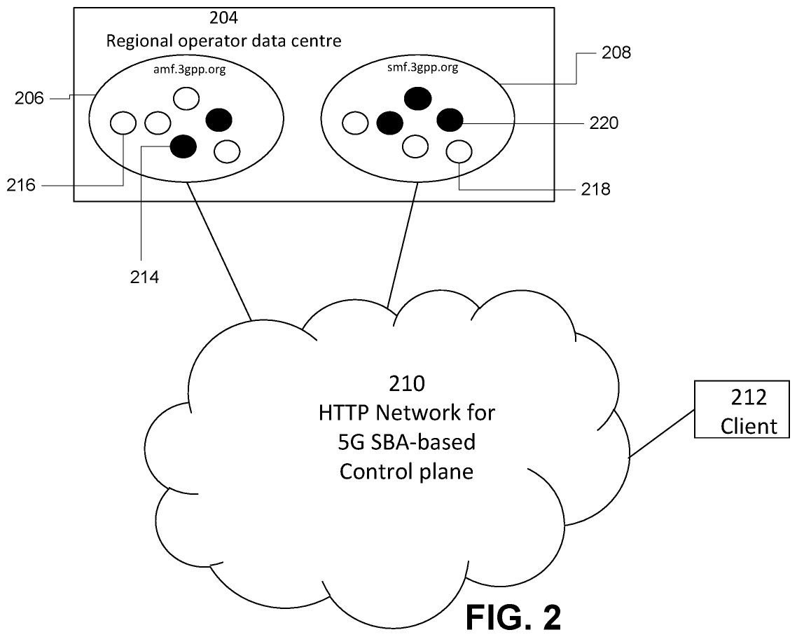

FIG. 2 shows an example of soft-slicing. A regional operator data center, at 204, may include service functions identified as amf.3gpp.org at 206 and as smf.3gpp.org at 208. At 206, amf.3gpp.org, may include one more service function instance such as service function instance 216 and service function instance 214. At 208, smf.3gpp.org, may include one or more service functions instances such as service function instance 218 and service function instance 220. The regional operator data centre 204 may be connected to the HTTP Network for 5G SBA-based Control plane at 210. Client 212 may be connected to the HTTP Network for 5G SBA-based Control plane at 210. As shown in FIG. 2, certain instances of the exemplary service functions (e.g., the black instances in FIG. 2, such as at 214 and 220) may be assigned to be used by a client.

Pinning may be different from whitelisting the use of resources by a consumer. For example, a WTRU may whitelist the usage of one or more service instances (e.g., the black instances at 214 and 220 in FIG. 2) over other instances (e.g., all other instances) of a specific service function. Service instances may or may not be exposed to a WTRU. Service instances (e.g., all service instances) may look the same to a WTRU (e.g., since each service instance exposes the same service identifier defined by its overall service function). One or more service instances (e.g., instances represented by the white circles in FIG. 2 at, for example, 216 and 218) may be indistinguishable from other service instances (e.g., the instances represented by the black circles in FIG. 2 at, for example, 214 and 220) from the perspective of the WTRU. The WTRU may be unable to compile an appropriate whitelist. Conversely, a whitelist at a service instance (e.g. each service instance) may define a WTRU (e.g. all WTRUs) it intends to serve. Whitelisting may not have the desired effect, e.g. since it may lead to effectively blacklisted WTRUs sending requests to the instance, which the instance would simply ignore (or the instance may reply with a negative response). This may lead to inefficiencies or undesired side effects.

Systems, methods, and instrumentalities described herein may allow for dynamic assignment of one or more service instances to a client by pinning specific SFCs to service instances at the application level.

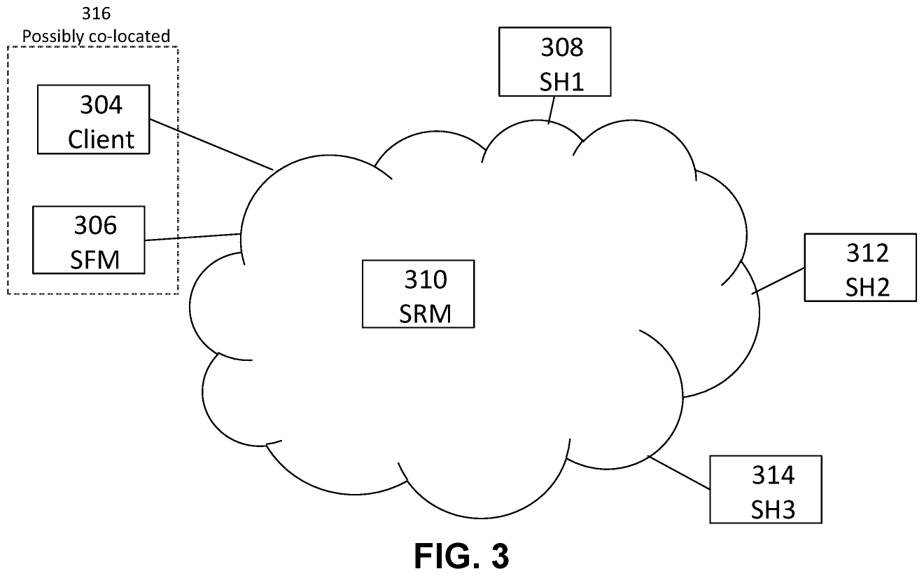

FIG. 3 illustrates an example system architecture. A service function manager (SFM), such as SFM 306, may be responsible for soliciting suitable service functions. Instances of service functions may be provided by one or more service hosts (e.g., SH1 at 308, SH2 at 312, and SH3 at 314 in FIG. 3). The SFM 306 may be a standalone management component (e.g., for a 3GPP SBA use case), or it may be collocated with the client device 304 (e.g., as indicated at 316 in FIG. 3). Collocation may be useful for some use cases, such as for a function offloading use case. The SFM 306 may be collocated with a Non-Access Stratum (NAS) engine, or a service based NAS engine with SFM capabilities that may request 3GPP specific services (e.g., PDU Session establishment) as the outcome of its solicitation operations.

A service registration manager (SRM), such as SRM 310, may be responsible for receiving registrations to a named service endpoint (e.g., a given URL) and exposing those named services in the network. SRM 310 may include SRR functions, may include an SRM that may be realized through RV/TM functionality, or may include DNS-based named registration in a link-local case (e.g., through advertisement via multicast DNS) or in a domain/global case (e.g., through injection into a DNS system of an ISP).

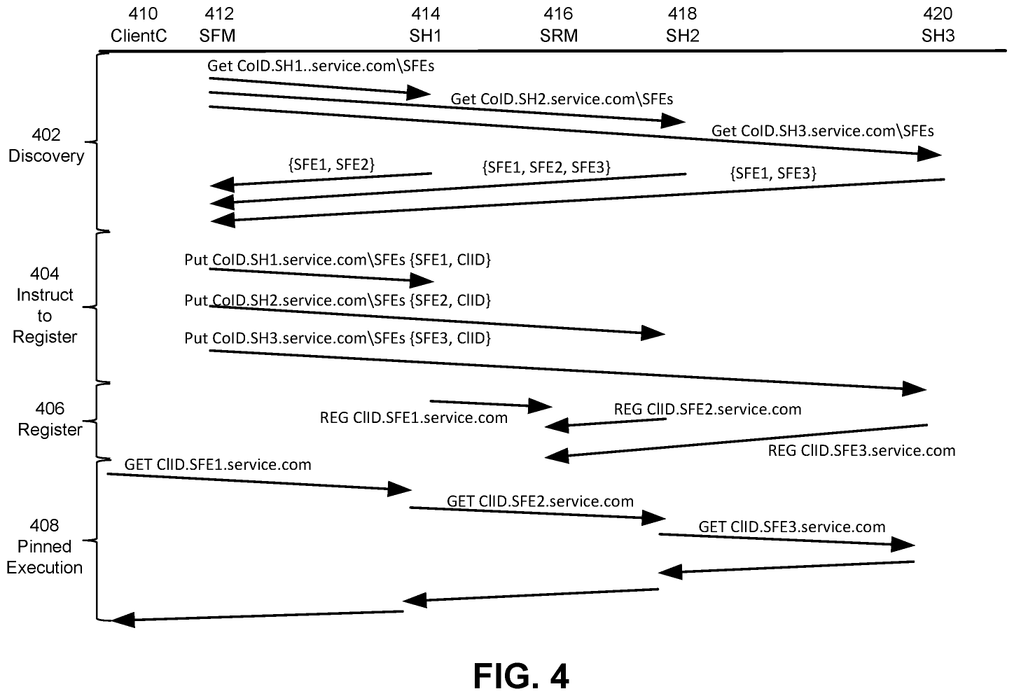

FIG. 4 illustrates an example message sequence chart that may be used for pinning one or more service functions to one or more service hosts. The messages shown in FIG. 4 are shown as exemplary HTTP methods. Other application protocols may be used.

A context ID (CoID) that may represent a reason for pinning service execution may be identified (e.g., for a use case). The CoID may be a device platform ID (e.g., an Android device ID), e.g., for the application function offloading use case. The CoID may be a slicing identifier (e.g., S-NSSAI), e.g. for the 3GPP SBA use case. The CoID may be a location identifier, such as a cluster name that may be used within a 5G network (e.g. 3GPP SBA use case).

Hosts (e.g., each host) of service functions may expose a service endpoint (e.g., CoID.SHx.service.com), under which a host is reachable. A host may be service host (SH), such as SH1 at 414, SH2 at 418, SH3 at 420.

Initiating clients (e.g., each initiating client) for an SFC may be represented by a Client ID (e.g., a CIID). A client may be Client_{c} at 410 and may be a WTRU. A CIID may be a device identifier or a subscription identifier. For example, the CIID may be a subscriber permanent identifier (SUPI) or a combination of a subscriber identity and unique equipment identity (e.g., an IMEI). The context ID-client ID relationship may be a basis for pinning. A context ID may be, e.g., an Android ID. An Android ID may be used to span several devices. Identifiers like IMEI may remain device-specific. An Android ID-based virtual device may be pinned to a specific execution device (e.g., one represented by a CIID). The WTRU identifier of an initiating device may be used for initiating pinning, e.g., since it is the device from which the service function chain initiates. Pinned SFCs may be initiated from devices (e.g., any device) associated with a mobile operator subscription (e.g., in scenarios with several devices being bundled under one subscription), e.g., by choosing an IMSI as a CIID.

An SFM, such as SFM 412, may solicit from one or more service hosts (e.g., each service host) a list of service functions that it exposes through discovery. For example, SFM 412 may solicit SH1 at 414, SH2 at 418, and/or SH3 at 420. Discovery, such as at 402, may be performed by direct HTTP-based interactions (e.g., utilizing naming schemes) or conforming to an agreed HTTP exchange (e.g., which may be subject to standardization).

The SFM, such as SFM 412, may determine, e.g. based on a selection mechanism, a set of service hosts to which it wants to assign a specific CIID. A selection mechanism may be regulatory related (e.g., where specific service hosts are required in a jurisdiction), Slice Selection Type (SST) based (e.g., where services satisfying a specific SST and Slice Differentiator may be found in a host), shortest path (e.g., where the SFM has path awareness through suitable interfaces to a transport network), weighted path (e.g., where the weight may be one or more metrics, which may include latency over congestion), authentication based (e.g., where the selection is tied into an authentication mechanism that may allow for selection of specific service instances when appropriate credentials and/or security relations may exist), or user interface based (e.g., where the SFM exposes the discovered service instances (e.g. with information on capabilities of the service instances) to an end user for selection through UI means).

The SFM, such as SFM 412, may instruct selected service hosts (e.g., each selected service host) to register a selected service function SFx (e.g., as CIID.SFx.service.com), such as shown at 404. At 406, service hosts (e.g., each service host) may register the selected service functions as instructed with the SRM, such as SRM 416. The service hosts may be SH1 at 414, SH2 at 418, and/or SH3 at 420. A client, such as Client_{c} 410, may initiate an SFC, e.g. by sending a request to CIID.SFE1.service.com. The end of selection may be coupled with the initiation of a first request to avoid racing conditions. There may be a notification from the SRM to the client, which may be a WTRU, or a notification from a management console (e.g., that manages overall selection of various service instances in the SFM).

Service instances (e.g., each service instance) being called may execute a service function according to SFC knowledge (e.g., provided through SFP information). A named relation (e.g., SFy.service.com) may be replaced with another (e.g., CIID.SFy.service.com), where the CIID is determined from an incoming request. SFy may represent the next named hop in the SFC. At 408, the service hosts (e.g. SH1 at 414, SH2 at 418, and SH3 at 420) may send client_{c} 410 an instruction to use the pinned service function end point name.

The embodiments disclosed herein may be applied to 3GPP for soft slicing. For example, there may be 3 different service hosts in regional data centers. A service function chain may be pinned by using authentication (which may be denoted as SF1), session management (which may be denoted as SF2), and policy function (which may be denoted as SF3), which may exemplify an authenticated attachment of a WTRU to a mobile network. The service function chain may be illustrated as:
WTRU->SF1->SF2->SF3->SF2->SF1->WTRU.

The context (e.g., which may provide a reason for pinning service instances to a given host) may be soft slicing, and a CoID may be a slicing identifier, which may represent a network slice to which the specific WTRU is assigned. An IMSI or other similar uniquely identifying device identifier may be used for a CIID. There may be a well-known FQDN for the advertisement of service functions by the service host (e.g., service.3gpp.org). At service hosts (e.g., each service host), service instances that may be meant to provide services to a specific network slice that may be identified as a CoID and may expose a service identifier (e.g., CoID.service.3gpp.org) for solicitation. Assignment of service instances to slices (e.g. specific slices) may be performed using slice management approaches.

An SFM may solicit supported service functions in the services hosts (e.g., each service hosts) using the service identifier. For example, the following configuration may be used (e.g., at the SFM) resulting from the solicitation:
SH1 hosts SF1 and SF3 for CoID
SH2 hosts SF1 and SF2 for CoID
SH3 hosts no service instance for the specific CoID.
   The SFM may choose to construct the service function chain for a specific CIID by picking either SH1 or SH2 for the execution of SF1. For example, for the given CoID and a specific CIID, the SFM may choose:
SH1 to execute SF3 only
SH2 to execute SF1 and SF2.
   SH2 may be chosen over SH1 for the execution of SF1 for, e.g., optimization of latency (e.g., by keeping the SF1<->SF2 sub-chain local) or keeping initial WTRU<->SF1 latency small (e.g., due to the WTRU being closer to SH1).

The SFM may instruct SH1 to register, for example, CIID.SF3.3gpp.org and SH2 to register, for example, CIID.SF1.3gpp.org and CIID.SF2.3gpp.org with the SRM. The WTRU may issue a request to, for example, CIID.SF1.3gpp.org. SF1 (e.g., executed in SH2) may determine the URI for a next function hop from the received request, e.g. by using a provided CIID sub-domain identifier in the incoming request. For example, SF1 may send a request to CIID.SF2.3gpp.org (e.g., executed in SH2), which may lead to a request to CIID.SF3.3gpp.org arriving at SH1.

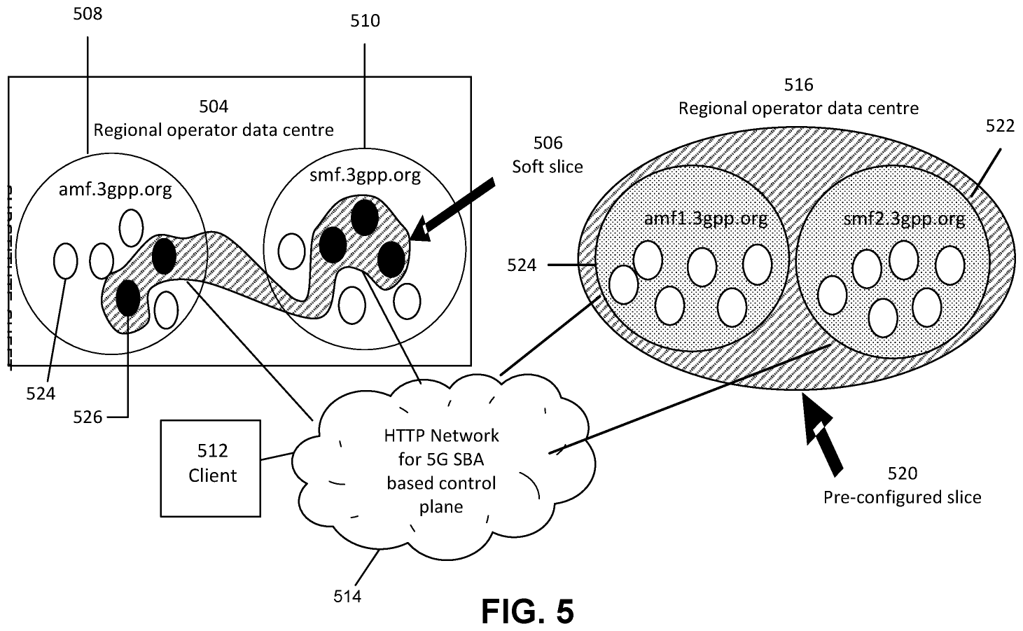

FIG. 5 illustrates an example system diagram that may be used to implement an SFM that may assign one or more resources to a client through a pinned SFC. As shown in FIG. 5, there may be one or more regional operator data centres, such as regional operator data centre 504 and regional operator data centre 516.

Regional operator data centre 504 may include one or more service functions, such as authentication service function 508 and session management function 510. Authentication service function 508 may include a number of service instances, such as service instance 524 and 526. Session management function 510 may include a number of service instances. Authentication service function 508 and session management function 510 may provide soft slice 506, which may include assigned service instances, such as service instance 526.

Regional operator data center 516 may include one or more service functions, such as authentication service function 524 and session management function 522. Authentication service function 524 may include a number of service instances. Session management function 522 may include a number of service instances. Authentication service function 524 and session management function 522 may provide pre-configured slice 520.

Client 512 may be connected to HTTP network for 5G SBA based control plane 514, which may be connected to regional operator data centre 504 and regional operator data centre 516.

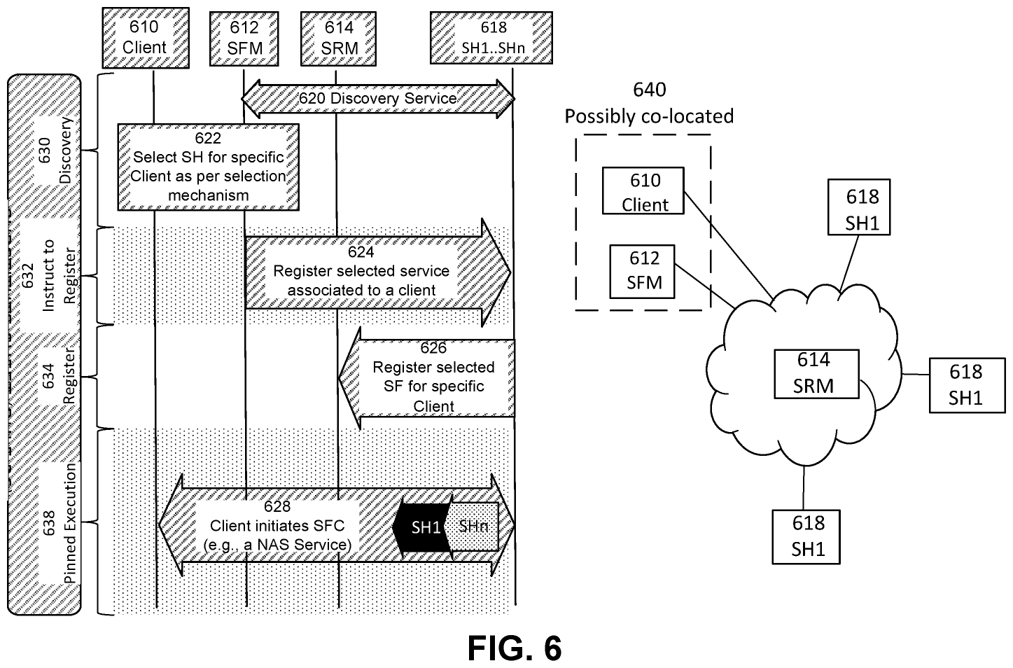

FIG. 6 illustrates an example system diagram that may be used to implement an SFM that may assign one or more resources to a client through a pinned SFC. Discovery may occur at 620. For example, SFM 612 may identify a service context based on one or more inputs that may be preconfigured or provided through a user interface, such as a network slice identifier or a unique device ID. SFM may discover a list of services from one or more hosts, such as SH1 . . . SHn at 618. This may occur via communication at 620 to discover services. SFM 612 may discover the list of services from the one or more hosts by addressing the hosts through a naming scheme derived from the service context SFM 612 may determine, based on a selection mechanism (e.g. a slice type), a set of services it wants to associate to client 610. At 622. SFM 612 selects a service host (SH) for client 610 as per selection mechanism.

At 632 one or more service hosts may be instructed to register a selected service. For example, an SFM may instruct a host with a service instance to register services for a client using a client ID for sub-naming, which may allow the client to initiate a pinned SFC addressed using a client ID associated with the service instance to the client. At 624, SFM 612 may instruct SH1 . . . SHn 618 to register the selected service such that the service may be associated to client 610.

At 634, registration may occur. For example, at 626. SH1 . . . SHn 618 may register selected service functions for client 610 and may notify SRM 614 of such registrations. At 638, pinned execution may occur. For example, at 628 client 610 may initiate SFC (e.g. a NAS service).

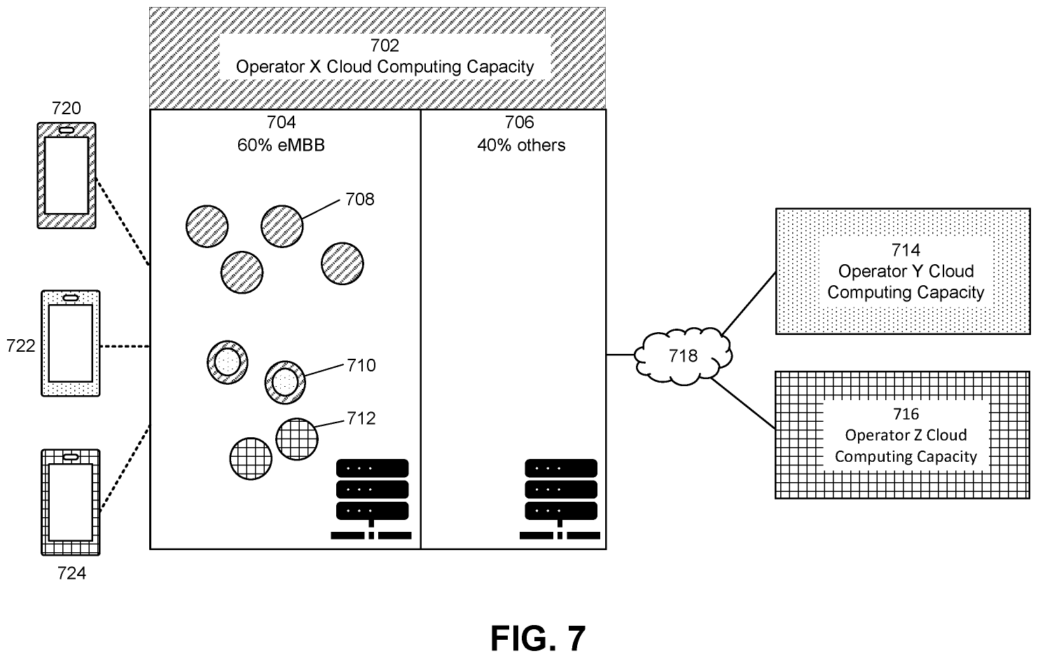

FIG. 7 illustrates an example system diagram that may be used to assignment a visiting customer quota within a service slice, such as a super slice. A super slice may be used in 5G. A super slice may be a pool of resources that may be assigned to a service, such as eMBB, across one or more customers (e.g. all customers). The customers may include roaming customers. The pool of resources may be assigned to a service, for example, utilizing the network of an operator, such as operator X. The assignment of the resources may be done across the customers (e.g. all customers) regardless of what relationship the home operator may have with the various customers (e.g. home customers at 720, visiting customers of operator Y at 722, and visiting customers of operator Y at 724).

Operator Y may have operator Y cloud computing capacity at 714. Operator Z may have operator z cloud computing capacity at 716. Operator x may have operator X cloud computing capacity at 702. Operator Y cloud computing capacity 714, operator Z cloud computing capacity 716, and operator X cloud computing capacity 702 may communicate via network 718. Operator x cloud computing capacity 702 may manage resources among one or more services. For example, Operator x cloud computing capacity 702 may provide 60% of resource to eMBB at 704, while reserving 40% resource at 706 for other services.

It may be desirable for the home operator, such as operator X, to assign resource quota to its own customers and one or more visiting customers (e.g. each visiting customer) of operators. The quota may be the outcome of a business negotiation between the home operator and the visiting operator. The quote may be a negotiated amount of resources between a customer and the home operator.

The home operator may control the resource usage within the service (e.g., eMBB) super slice by pinning customers to resource instances in the overall resource pool according to the negotiated resource quote. At 708, a resource assignment may be made for home customers of operator X. At 712, a resource assignment may be made (e.g. exclusively made) for visiting customers of operator Z. At 710, a resource assignment may be shared (e.g. contentiously shared) between the customers of operator X and operator Y. The resource assignment for the home operator may be the size of the super slice minus those resources that may be exclusively assigned to visiting customers, such as at 712 for customers of operator Z.

Super slice control of resources within a managed resource pool may be the result of a long-term planning decision on how many resources may be assigned to a service (slice). The specific assignment within said (long term planned) quota, however, might be realized dynamically based on conditions such as network load, geographical distribution of WTRUs, and others. This may be realized through pinning, within the slice, by assigning the slicing identifier as the ContextID and the Mobile Network Identifier (MNI) as the ClientID. Assigning the slicing identifier as the ContextID by identifying the super slice of resources (e.g. all resources) assigned to this slicing identifier. Any SFC initiated by a client of a customer with an MNI may utilize the pinned resource quote assigned to the MNI with the slicing identifier.

Implementations used at an SFM may be integrated into a WTRU, e.g. for application function offloading. A service host may be a WTRU, e.g. for application function offloading. Service endpoints may be located on a (e.g., small) device surrounding a user's main device, e.g. in fog systems. Fog systems may offload tasks similar to those in an application function offloading case. Service hosts may be located on terminal devices.

Embodiments described herein may be detected through packet inspection, e.g. in application protocol realizations (e.g., via HTTP). Naming for selecting specific service instances may be exposed to a transport network and visible in an interaction.

Although features and elements may be described above in particular combinations or orders, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-18. (canceled)

19. A device for implementing a service function manager (SFM) to assign one or more resources to a client through a pinned service function chain (SFC), the device comprising:
a memory, and
a processor, the processor configured to:
identify a service context and a client identifier associated with the client;
discover one or more assignable resources that can be assigned to the client using the service context;
assign one or more resources to the client from the one or more assignable resources;
determine a resource naming scheme using the client identifier and the service context;
generate a resource address for the assigned one or more resources using the resource naming scheme;
send a first message to a host to register the assigned one or more resources to the client under the resource address for the assigned one or more resources; and
send a second message to the client that comprises the resource address for the assigned one or more resources to initiate the pinned SFC.

20. The device of claim 19, wherein the host provides a resource from the assigned one or more resources to the client.

21. The device of claim 19, wherein the processor is further configured to identify the service context using one or more of a configuration and a user input.

22. The device of claim 19, wherein the processor is further configured to discover the one or more assignable resources that can be assigned to the client using the service context by:
deriving a service naming scheme from the service context; and
addressing the one or more assignable resources using the service naming scheme.

23. The device of claim 19, wherein the processor is further configured to discover the one or more assignable resources that can be assigned to the client using the service context by:
determining a list of resources from the host;
determining a selection criterion for the client; and
determining the one or more assignable resources that can be assigned to the client from the list of resources using the selection criterion for the client.

24. The device of claim 19, wherein the processor is further configured to discover the one or more assignable resources that can be assigned to the client using the service context by:
determining a list of resources from the host; and
determining the one or more assignable resources that can be assigned to the client from the list of resources using a slice type.

25. A wireless transmit/receive unit (WTRU) for implementing a service function manager (SFM) to assign one or more resources to a client through a pinned service function chain (SFC), the WTRU comprising:
a memory, and
a processor, the processor configured to:
identify a service context and a client identifier associated with the client;
discover one or more assignable resources that can be assigned to the client using the service context;
assign the one or more resource to the client from the one or more assignable resources;
determine a resource naming scheme using the client identifier and the service context;
generate a resource address for the assigned one or more resources using the resource naming scheme;
send a first message to a host to register the assigned one or more resources to the client under the resource address for the assigned one or more resources; and
send a second message to the client that comprises the resource address for the assigned one or more resources to initiate the pinned SFC.

26. The WTRU of claim 25, wherein the host provides at a resource from the assigned one or more resources to the client.

27. The WTRU of claim 25, wherein the processor is further configured to identify a service context using one or more of a configuration and a user input.

28. The WTRU of claim 25, wherein the processor is further configured to discover the one or more assignable resources that can be assigned to the client using the service context by:
deriving a service naming scheme from the service context; and
addressing the one or more assignable resources using the service naming scheme.

29. The WTRU of claim 25, wherein the processor is further configured to discover the one or more assignable resources that can be assigned to the client using the service context by:
determining a list of resources from the host;
determining a selection criterion for the client; and
determining the one or more assignable resources that can be assigned to the client from the list of resources using the selection criterion for the client.

30. The WTRU of claim 25, wherein the processor is further configured to discover the one or more assignable resources that can be assigned to the client using the service context by:
determining a list of resources from the host; and
determining the one or more assignable resources that can be assigned to the client from the list of resources using a slice type.

31. A method for a device to provide a service function manager (SFM) to assign one or more resources to a client through a pinned service function chain (SFC), the method comprising:
identifying, by the device, a service context and a client identifier associated with the client;
discovering, by the device, one or more assignable resources that can be assigned to the client using the service context;
assigning, by the device, one or more resources to the client from the one or more assignable resources;
determining, by the device, a resource naming scheme using the client identifier and the service context;
generating, by the device, a resource address for the assigned one or more resources using the resource naming scheme;
sending, by the device, a first message to a host to register the assigned one or more resources to the client under the resource address for the assigned one or more resources; and
sending, by the device, a second message to the client that comprises the resource address for the assigned one or more resources to initiate the pinned SFC.

32. The method of claim 31, wherein the method further comprises identifying a service context using one or more one of a configuration and a user input.

33. The method of claim 31, wherein the method further comprises discovering the one or more assignable resources that can be assigned to the client using the service context by:
deriving the service naming scheme from the service context; and
addressing the one or more assignable resources using the service naming scheme.

34. The method of claim 31, wherein the method further comprises discovering the one or more assignable resources that can be assigned to the client using the service context by:
determining a list of resources from the host;
determining a selection criterion for the client; and
determining the one or more assignable resources that can be assigned to the client from the list of resources using the selection criterion for the client.

35. The method of claim 31, wherein method comprises discovering, by the device, the one or more assignable resource that can be assigned to the client using the service context by:
determining a list of resources from the host; and
determining the one or more assignable resources that can be assigned to the client from the list of resources using a slice type.

36. The method of claim 31, wherein the host proves the assigned resource to the client.
